(19) United States
(12) Patent Application Publication
(10) Pub. No.: US 2025/0069022 A1
(43) Pub. Date: Feb. 27, 2025

(54) INFORMATION PROCESSING SYSTEM AND SERVER, INFORMATION PROCESSING METHOD, AND PROGRAM

(71) Applicant: AERONEXT INC., Tokyo (JP)

(72) Inventors: Tadanari HIGUCHI, Ogaki-shi (JP); Shuji KAWAI, Chuo-ku (JP); Kento KONDO, Shibuya-ku (JP); Keisuke TOJI, Shibuya-ku (JP); Takuya HORI, Shibuya-ku (JP)

(21) Appl. No.: 18/725,009

(22) PCT Filed: Dec. 27, 2022
(86) PCT No.: PCT/JP2022/048127

§ 371 Date: Jul. 9, 2024

(30) Foreign Application Priority Data
Dec. 27, 2021 (JP) 2021-212589

(51) Int. Cl. G06Q 10/083

(52) U.S. Cl. CPC G06Q 10/083

(57) ABSTRACT

The present disclosure includes: a residual space calculation part that calculates residual space information indicating a residual space in the storage space based on storage container type information indicating a storage container type information indicating a storage container type for each volume of a storage container that stores delivery payloads for a user and reference storage space volume information indicating a volume of the storage space that stores one or more storage containers; and a consolidation target delivery extraction part extracts consolidation target delivery information indicating deliveries by other users that can be consolidated with the user's delivery payload in the residual space.

### TECHNICAL FIELD

This disclosure relates to information processing systems and servers, information processing methods, and programs.

### BACKGROUND ART

In recent years, flying objects such as drones (drones) and unmanned aerial vehicles (UAVs) and moving objects such as unmanned ground vehicles (UGVs) have begun to be used in industry. Patent Literature 1 discloses the delivery of delivery payloads using flying objects.

### PRIOR ART LIST

### Patent Literature

[Patent Literature 1] JP2021-160887A

### SUMMARY OF THE INVENTION

### Technical Problem

As disclosed in Patent Literature 1, in such a delivery system, it is assumed that multiple moving objects will be the delivery control target. However, in the demonstration experiment, a test delivery flight is performed by setting a virtual delivery load (e.g., daily necessities, food, etc.) within the range that can be loaded onto a single moving object, and at a time when the predetermined route can be flown.

However, in reality, users do not usually order items while being aware of the load capacity of a single moving object, and they usually order the items they want in the quantities they want at the times they want them, so there is no way of predicting how much can be loaded onto a single moving object (in other words, how much of the remaining space in the storage part of the moving object, etc., is available). On the other hand, it is known that high delivery efficiency leads to lower delivery costs (and therefore lower delivery fees), so it is desirable for both the service provider and the user to be able to load as much as possible onto a single moving object. These issues are not limited to moving objects, but also apply to conventional delivery methods.

In light of this background, the present disclosure aims to provide an information processing system and server, an information processing method, and a program that make it easier to comprehensively grasp the quantity of delivery payloads (e.g., loads such as packages) by standardizing and managing them using containment vessel type identification information, thereby enabling efficient storage in various containment spaces.

### Technical Solution

The main technology of this disclosure for solving the above problem is an information processing system or the like that includes, based on storage container type information indicating the type of container for storing a delivery payload for a user according to the volume of the container, and reference storage space volume information indicating the volume of the storage space that contains one or more storage containers, a residual space calculation part that calculates residual space information indicating the remaining space within the aforementioned storage space, and a consolidation target delivery extraction part that extracts consolidation target delivery information indicating the delivery payloads of other users that can be consolidated with the user's delivery payload in the residual space.

### Advantageous Effects

According to the present disclosure, by using storage container type information to standardize and manage delivery payloads (e.g., loads such as packages), it is possible to provide an information processing system and server, information processing method, and program that facilitate the comprehensive understanding of the quantity of delivery payloads and enable efficient storage in various storage spaces.

### BRIEF DESCRIPTION OF THE DRAWINGS

FIG. 1 shows a configuration of an information processing system in this embodiment of the present disclosure.

FIG. 2 shows a block diagram of the hardware configuration of the management server in FIG. 1.

FIG. 3 shows a block diagram of the hardware configuration of the user terminal and the operator terminal in FIG. 1.

FIG. 4 shows a block diagram of the functions of the management server in FIG. 1.

FIG. 5 shows a block diagram showing the structure of the storage in FIG. 2.

FIG. 6 shows an example that explains a calculation of residual space in this embodiment of the present disclosure.

FIG. 7 shows a block diagram showing the structure of the delivery information storage part in FIG. 5.

FIG. 8 shows a flowchart of the information processing method of this embodiment of the present disclosure.

FIG. 9 shows an example of a display screen for this embodiment of the present disclosure.

### SUMMARY OF THE INVENTION

The contents of this embodiment will be explained by listing them. The information processing system or the like of this embodiment comprises the following.

### Item 1

An information processing system, comprising:
a residual space calculation part that, based on storage container type information indicating the type of each storage container according to the volume of the storage container that stores a delivery payload for a user and reference storage space volume information indicating the volume of the storage space that stores one or more storage containers, calculates residual space information indicating a residual space within the storage space; and
a consolidation target delivery extraction part that extracts consolidation target delivery information indicating a delivery payload of other users that can be consolidated with the delivery payload of the user in the residual space.

### Item 2

The information processing system according to item 1,
wherein the storage container type information is made mutually identifiable based on the volume obtained by dividing the reference storage space volume by a predetermined number, with the predetermined storage space volume serving as the reference storage space volume.

### Item 3

The information processing system as in item 1 or item 2,
wherein the residual space information is residual converted storage container type information that converts the residual space into storage container types.

### Item 4

The information processing system as in any one of items 1 to 3, further comprising:
a data management part that transmits the extracted consolidation target delivery information to an operator terminal.

### Item 5

A server, comprising:
a residual space calculation part that, based on storage container type information indicating the type of storage container for storing a delivery payload for a user and reference storage space volume information indicating the volume of a storage space that stores one or more storage containers, calculates residual space information indicating the residual space in the storage space; and
a consolidation target delivery extraction part that extracts consolidation target delivery information indicating a delivery payload of other users that can be consolidated with the delivery payload of the user in the residual space.

### Item 6

An information processing method, comprising:
a step of calculating, based on storage container type information indicating the type of storage container for storing a delivery payload for a user and reference storage space volume information indicating the volume of a storage space that stores one or more storage containers, residual space information indicating a residual space within the storage space;
a step of extracting consolidation target delivery information indicating a delivery of another user that can be consolidated with the delivery payload of the user in the residual space by the consolidation target delivery extraction part.

### Item 7

A program, comprising:
a step of calculating, based on storage container type information indicating the type of storage container for storing a delivery payload for a user and reference storage space volume information indicating the volume of the storage space that stores one or more storage containers, residual space information indicating the residual space within the storage space;
a step of having the consolidation target delivery extraction part extract consolidation target delivery information indicating the delivery of another user that can be consolidated with the delivery payload of the user in the residual space.

### Embodiment 1

The following explains the information system or the like, based on the first embodiment of this disclosure. In the attached drawings, identical or similar elements are given identical or similar reference numerals and names, and in the description of each embodiment, duplicative descriptions of identical or similar elements may be omitted. In addition, the features shown in this embodiment are also applicable to other embodiments, as long as they do not contradict each other.

### <Configuration>

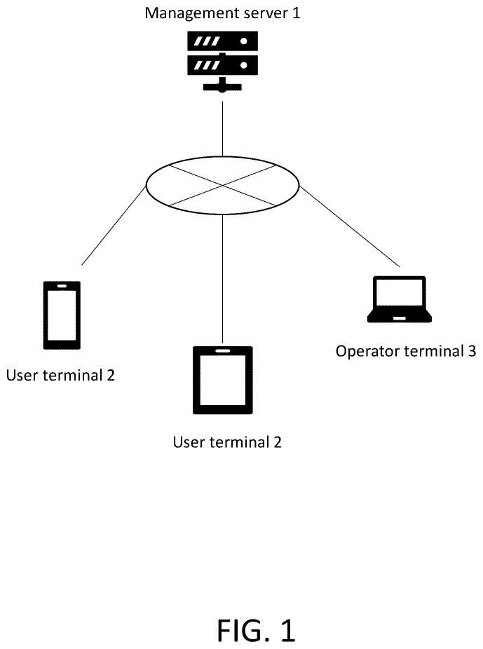

As shown in FIG. 1, the information processing system in this embodiment has a management server 1, one or more user terminals 2, and one or more user terminals 2. The management server 1, user terminal(s) 2, and operator terminal(s) 3 are connected to each other in a way that allows them to communicate via a network. The configuration shown in the figure is just one example and is not limited to this.

### <Management Server 1>

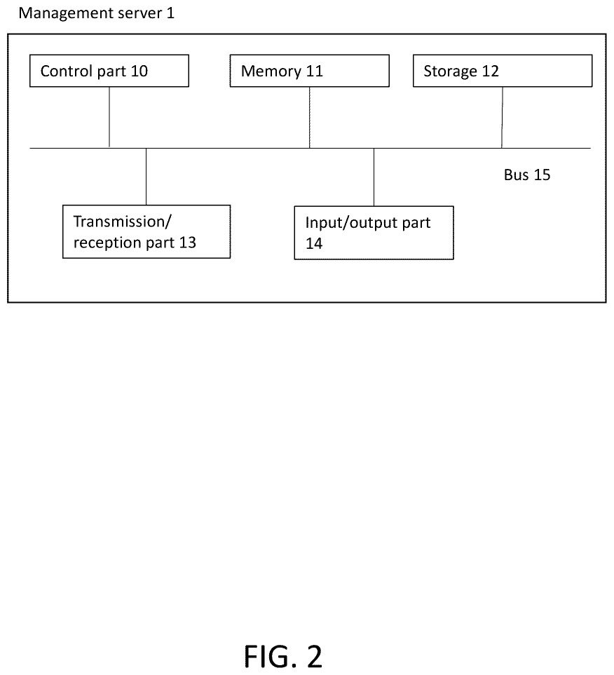

FIG. 2 shows the hardware configuration of the management server 1. Note that the configuration shown in the figure is just an example, and other configurations may be used.

As shown in the figure, the management server 1 is connected to one or more user terminal(s) 2 and one or more operator terminal(s) 3, and comprises part of the system. the management server 1 may be a general-purpose computer, such as a workstation or personal computer, or it may be logically realized through cloud computing.

At least a control part 10, a memory 11, a storage 12, a transmission/reception part 13, and an input/output part 14 are provided in the management server 1, and these are electrically connected to each other via a bus 15.

The control part 10 is a computing device that controls the overall operation of the management server 1, controls the transmission and reception of data between each element, and performs information processing necessary for executing applications and authentication processing. For example, the control part 10 is a CPU (central processing unit) and/or a GPU (graphics processing unit), and it executes programs for this system stored in the storage 12 and deployed in the memory 11 to perform each information processing.

The memory 11 comprises a main memory comprising a volatile storage device such as DRAM (dynamic random access memory), and an auxiliary memory comprising a non-volatile storage device such as flash memory or HDD (hard disk drive). The memory 11 is used as a work area or the like for the processor 10, and also stores the BIOS (Basic Input/Output System) that is executed when the management server I is started, as well as various setting information, etc.

The storage 12 stores various programs such as application programs or the like. A database storing data used in each process may be constructed in the storage 12.

The transmission/reception part 13 connects the management server 1 to the network and blockchain network. In addition, the transmission/reception part 13 may be equipped with a short-range communication interface for Bluetooth (registered trademark) and BLE (Bluetooth Low Energy).

The input/output part 14 is an input device such as a keyboard or mouse or the like, and an output device such as a display or the like.

The bus 15 is connected to each of the above elements in common, and transmits address signals, data signals, and various control signals, for example.

<User terminal 2, operator terminal 3>

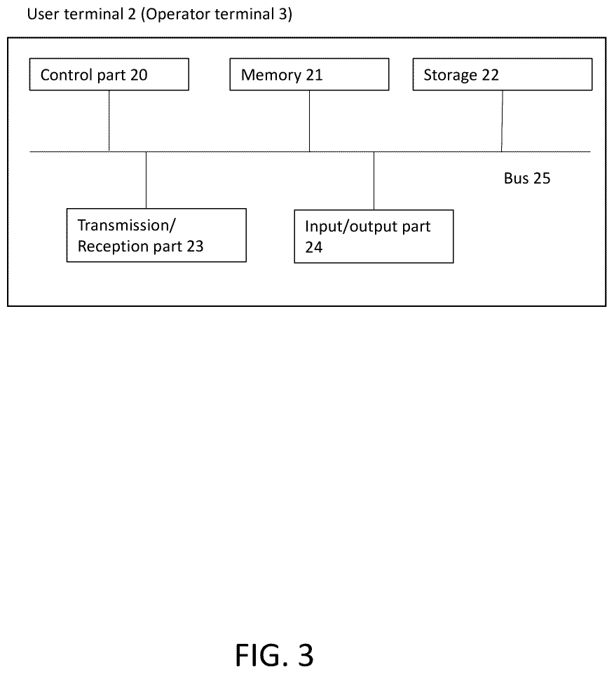

As shown in FIG. 3, a user terminal 2 is an information processing device, such as a personal computer, a tablet terminal, a smartphone, a mobile phone, a PHS, or a PDA, that is carried by a user. The user terminal 2 is also equipped with a control part 20, a memory 21, a storage 22, a transmission/reception part 23, and an input/output part 24, which are electrically connected to each other via a bus 25. As the main functions of each element can be comprised in the same way as the management server 1 described above, a detailed explanation of each element is omitted. In addition, an operator terminal 3 is an information processing device such as a personal computer, a tablet terminal, a smartphone, a mobile phone, a PHS, or a PDA, etc., which is carried by the operator who manages the delivery payload at a collection point, etc. The main functions of each element can be comprised in the same way as the user terminal 2 described above, so a detailed explanation of each element is omitted.

### <Functions of the Management Server>

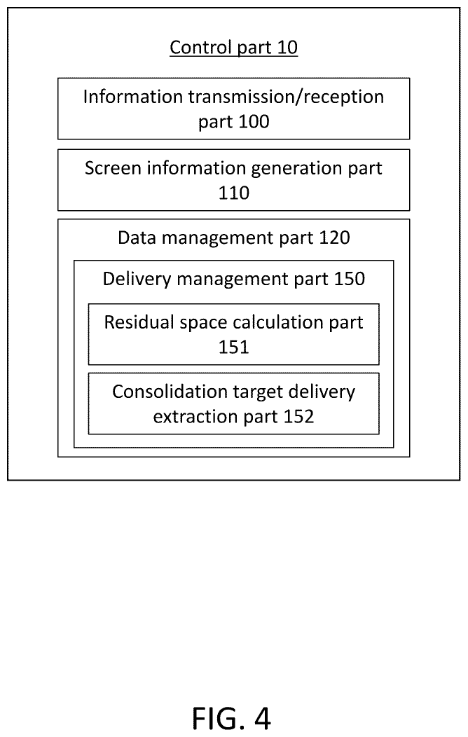

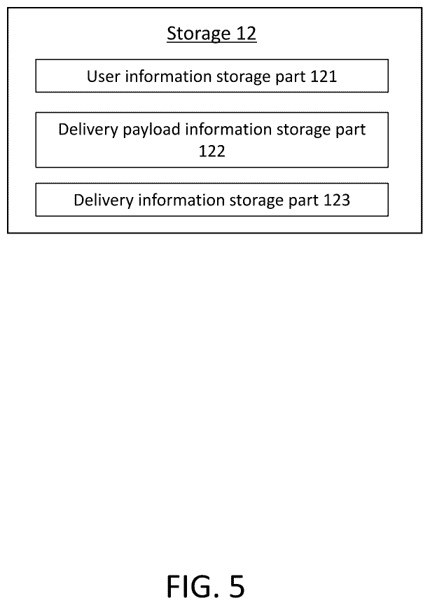

FIG. 4 is a block diagram illustrating the functions implemented in the control part 10 of the management server 1, and FIG. 5 is a block diagram illustrating the information stored in the storage 12. In this embodiment, the control part 10 of the management server 1 has the following function parts: information transmission/reception part 100, screen information generation part 110, data management part 120, and delivery management part 150. The delivery management part 150 includes a residual space calculation part 151 and a consolidation target delivery extraction part 152. In addition, the storage 12 includes various databases such as a user information storage part 121, a delivery payload information storage part 122, and a delivery information storage part 123.

User information stored in a user information storage part 121 may include, for example, basic user information (such as the user's name, user name, email address, address, and telephone number, or the like), user identification information, and external application account information, or the like, but is not limited to these. For example, when conducting electronic commerce on this information processing system or on an external system that is linked to this system by transmitting or receiving related information, the user information may include payment information (such as credit card information or the like), purchased product information (including purchase cost information or the like), purchase history information, desired purchase product information (such as so-called “favorite” registered product information or product information in a wish list or the like), and subscription purchase product information (described below).

Delivery payload information stored in the delivery payload information storage part 122 may include, for example, delivery payload identification information, user identification information, storage container type information, size information (depth, width, height), weight information, controlled temperature range information, top/bottom stacking possibility information (top stacking or bottom stacking possibility information), delivery schedule information (scheduled delivery start time, scheduled delivery end time, scheduled delivery time slot information), consolidation target delivery information, consolidation target delivery acceptance availability information, delivery cost information, etc., but these are not limited to these.

The delivery information stored in the delivery information storage unit 123 may include, for example, delivery identification information, user identification information, delivery payload identification information, remaining space information, delivery payload information for consolidation, delivery type information, and delivery schedule information (delivery start time information, delivery end time information, and scheduled delivery time slot information). In addition, it may also include storage container type information, weight information, temperature range information, consolidation target delivery acceptance/rejection information, delivery cost information, etc., which are linked to the delivery payload information, but these are not limited to these.

The information transmission/reception part 100 sends various information (including requests) to external devices (e.g., user terminals 2, worker terminals 3, etc.) that are directly or indirectly connected to the management server 1 via a network, and receives various information (including requests) from external devices.

The screen information generation part 110 generates screen information that is displayed via the user interface of the user terminal 2 or the worker terminal 3. The screen information can be user interface screen information that is generated by arranging various images and text based on predetermined layout rules, using images and text data stored in storage 12 as resources. In addition, the screen information generation part 110 may be a function part executed by the control part 20 using the application (including web browsers) stored in each user terminal 2, etc. In other words, it is also possible to transmit the necessary information from the management server 1 to generate the user interface screen, such as image data, and to have the application in user terminal 2, etc. generate the user interface screen based on the necessary information and display it on the user terminal 2, based on the specified layout rules. The processing related to the screen information generation part 110 can also be executed by a GPU (Graphics Processing Unit).

The data management part 120 performs data management such as sending various information received by the information transmission/reception part 100 to various function parts and acquiring various information from various function parts. The predetermined processing in the data management part 120 includes various processing, including the following processing, but is not limited to these: a residual space calculation process that calculates the residual space within the storage space based on user delivery information that includes storage container type information indicating the type of storage container for each volume of the storage container that stores the delivery payload for the user and reference storage space volume information indicating the volume of the storage space that stores one or more storage containers: a consolidation target delivery information extraction process that extracts delivery information for other users' deliveries that can be consolidated with the user's delivery in the residual space: a delivery information update process that updates (including adding) the consolidation target delivery payload information (such as consolidation target delivery payload identification information) contained in the delivery information.

The shape of the storage container should be a geometric solid container, and considering factors such as storage in the storage space and stacking, a rectangular parallelepiped (including a cube) is preferable. The material of the storage container can be any material, such as paper, plastic, or metal, and in particular, it is desirable from the perspective of ease of production and weight to be made of paper or plastic corrugated cardboard. In this disclosure, the type of storage container is set so that the type of storage container can be identified for the stored items, such as deliveries. The types of storage containers, for example, may include types of multiple storage container volumes that are set to be distinguishable from each other based on the volume obtained by dividing the reference storage space volume, which serves as the standard storage space volume, by a predetermined number (for example, an integer). These may include types of multiple storage container volumes that are set to be distinguishable from each other based on the volume obtained by dividing the reference storage space volume by a predetermined number (for example, an integer) and then multiplying by a number not exceeding the predetermined number (for example, ⅓, ⅔, 1, or ¼, ½, ¾, 1, etc.), as well as types of multiple storage container volumes that are set to be distinguishable from each other based on the volume obtained by dividing by a predetermined number (for example, an integer) and particularly by a power of 2 (n is an integer and may include 0) (for example, ½, ¼, ⅛, etc.), and it is not limited to these. Furthermore, with regard to the volume of the storage container, more specifically, for example, when the standard storage space volume is divided by 4 (i.e., when it is divided by ¼), it may be a storage container with a volume obtained by dividing either the depth, width, or height of the storage space by 4, or it may be a storage container with a volume obtained by dividing two of the depth, width, and height of the storage space by 2.

Furthermore, the standard storage space volume does not have to be the same as the predetermined storage space volume, but may be substantially the same (substantially the same). In particular, it may be a volume reduced by the amount of extra space (e.g. a few millimeters or centimeters) required in view of the work of storing containers in the storage space. In addition, if a partition is installed inside the container, the volume may be reduced by the amount of the partition (e.g. a few millimeters or centimeters) (or, if the storage space is substantially the same volume as the standard storage space volume, it may be larger by the amount of the partition).

The storage space for the user's stored items and/or the storage space targeted for the standard storage space volume may be based on any space with a predetermined volume. However, it is preferable that the storage space is for receiving stored items, and more specifically, it may be a storage space for items used by the user, such as a storage space for the user, a delivery box with a smart lock installed in a private residence, or a delivery box placed in a common area for a multi-unit residence, or a storage space for a shelf or locker that does not involve electrical locking and unlocking control, a private mailbox, or a cold storage box. For the delivery box storage space, the location of the space may be determined in advance by linking it to information related to the user, or it may be the location where the load is stored by the delivery person by linking it to information related to the user. It may also be a movable object such as the storage part of a moving object (such as a UAV or UGV, especially an autonomous moving object) used to deliver a load, a load carrier (such as a truck bed, a motorcycle rear box, a box dolly, or a basket dolly) used by a delivery person for delivery, or a delivery bag. Furthermore, the space with a predetermined volume may be a space with a predetermined length in the depth, width, and height directions as described above, but it may also be a space with a volume that has a virtually set length in the height direction for a region with a predetermined length in the depth and width directions, such as a pallet. Furthermore, this is not limited to these examples. In addition, the storage space to be stored and the reference storage space may be the same, or the storage space to be stored may be a size equal to a predetermined number (in particular, an integer) multiplied by the reference storage space.

The delivery management part 150 performs information registration such as adding delivery identification information and associating user identification information in the delivery information storage part 123 in accordance with, for example, delivery payload acceptance processing, such as reading the identification code (for example, reading 2D barcodes, RFID tags, NFC, etc.) attached to the delivery payload using readers (for example, readers operated by workers, stationary readers, readers on work robots (especially autonomous work robots)), or inputting the delivery payload information by workers, etc.

The residual space calculation part 151 calculates the residual space (i.e. the so-called empty space) within the target storage space based on the reference storage space volume information indicating the volume of the storage space that stores one or more storage containers, and the storage container type information (i.e. including the storage container type information as delivery payload information linked to the delivery information) acquired in accordance with the delivery information. The residual space is calculated using a known box-packing calculation algorithm for storing a given object in a given volume of space. In particular, where the storage container type is specified for each predetermined volume of the reference storage space volume in accordance with the predetermined rules as described above, the residual space can be easily converted into a volume value that is easy to convert into a storage container type, making it easier to obtain residual converted storage container type information by converting the residual space into a storage container type. It becomes easier to calculate the residual space within the storage space, in particular, when the depth, width, or height of the storage space is set to be identifiable in terms of the storage container volume, which is calculated by dividing the above-mentioned predetermined number by a predetermined number and multiplying by a number less than the predetermined number, or when the types of storage container volume, which are set to be identifiable for each storage container volume divided by a predetermined number. In addition, when the storage space is divided into sections corresponding to one of the container types using partitions or other means, the delivery information storage part 124 stores partition area identification information that can be identified for each area divided by partitions, etc. in the target storage space, in association with the delivery identification information. It also stores the corresponding storage container type information for the partition area identification information. The residual space calculation part 151 may use the partition area identification information as the residual space information.

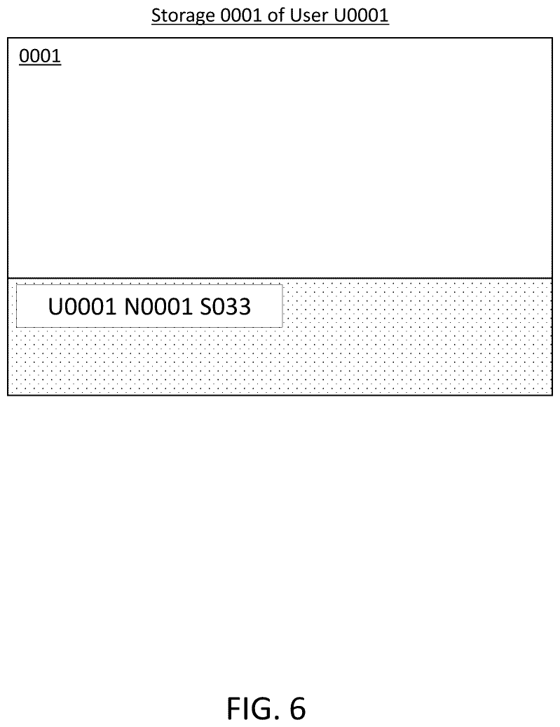

Here, FIG. 6 is used to provide a simplified example of calculating residual space in the case where the type of storage container is specified for each predetermined volume relative to the reference storage space volume. The example given here is for the types of storage container volume (e.g. ⅓, ⅔, 1) that can be identified by dividing the reference storage space volume by 3 and multiplying by a number not exceeding 3.

First, the user information “U0001” is linked to the storage space associated with the delivery identification information “0001”. When a delivery payload (delivery payload information “N0001”) is stored in a container (storage container type “S033”) that is one third of the reference storage space volume, since the delivery payload is stored in a storage space that has not yet been filled, the residual space information is updated to “⅔” by subtracting 1 from ⅓, and the residual converted storage container type information is updated to indicate two “S033”s and/or one “S066” (storage container type information indicating a container that is two-thirds the reference storage space volume).

Similarly, when a delivery payload (delivery payload information “N0010”) is stored in a container that is one-third of the reference storage space volume (storage container type “S033”), in order to store it in the storage space that already contains the delivery payload (N0001), the residual space information is updated from ⅔ to “⅓” by subtracting ⅓, and the residual converted storage container type information is updated as information indicating that there is one “S033” container.

As shown in the example, calculating the residual space in this way becomes more straightforward when the depth, width or height of the storage space is divided by a predetermined number. Furthermore, as mentioned above, it is possible to calculate the residual space using a known box-packing calculation algorithm, and in that case, it may be possible to reorganize the storage locations of the stored delivery payloads.

In addition, when the storage space is divided into separate areas corresponding to one of the storage container types, such as by partitions, etc., rather than storing in the common area within the storage space as in the above example, the residual space information may be the partition area identification information without any association with the stored items, and the residual converted storage container type information may be the corresponding storage container type information corresponding to the partition area identification information without any association with the stored items. The location of the partitions can be adjustable. The corresponding storage container type information can be changed (for example, “S033” can be changed from two containers to one “S066” container, or vice versa). In addition to one corresponding storage container type information (e.g., “S066”) corresponding to each partition area identification information, there may also be multiple corresponding storage container type information (e.g., two “S033”) associated with it instead of or in addition to this.

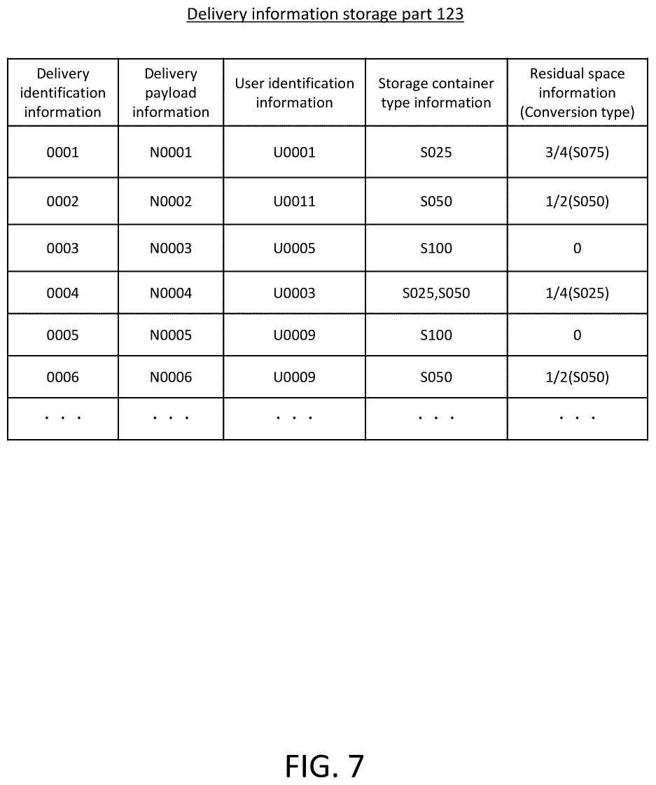

Here, using FIG. 7, an example of the information (in particular, residual space information) stored in the delivery information storage part 123 is shown. First, for the delivery identification information “0001”, it is shown that the delivery payload information is “N0001” and the user information is “U0001”, and that one storage container type information, “S025”, indicating a container type that is one quarter of the reference storage space volume, is stored. Therefore, the residual space information is calculated as “¾” (residual converted storage container type information indicates a container type that is three-quarters of the reference storage space volume, “S075”).

Next, for the delivery identification information “0002”, the linked delivery payload information is “N0002” and the user information is “U0011”, and it is shown that one “S050” storage container type information, which indicates a container type that is half the reference storage space volume, is stored. Therefore, the residual space information is calculated as “½” (residual conversion storage container type information indicating the container type for one-half of the reference storage space volume information “S050”).

Next, for the delivery identification information “0003”, the linked delivery payload information is “N0003” and the user information is “U0005”, and it is indicated that one “S100” storage container type information, which indicates a container type that is substantially the same as the reference storage space volume, is stored, so the residual space information is calculated as “0” (i.e., no space available).

Next, for the delivery identification information “0004”, the delivery payload information is “N0004” and the user information is “U0003”, and it is shown that the storage container type information contains one of the above-described “S025” (with the top stacking prohibition indicated by the top stacking possibility information) and one “S050”. Therefore, the residual space information is calculated as “¼” (residual conversion storage container type information indicates a container type that is one-quarter of the reference storage space volume information “S025”).

Finally, for the delivery identification information “0005” and “0006”, the linked delivery payload information is “N0005” and “N0006”, and the user information is “U0009”, and as storage container type information, it is shown that one “S100” and one “S050” are stored, so the residual space information is calculated as “0” and “½”. In this case, the actual residual space for the user of user information “U0009” for this delivery can be said to be “½” (residual conversion storage container type information indicates a container type of half the reference storage space volume, “S050”).

In this way, the residual space calculation part 151 is able to calculate the residual space within the target storage space based on the reference storage space volume information, which indicates the volume of the storage space that contains one or more storage containers, and the storage container type information, which indicates the type of each storage container volume that contains the delivery payload to the user. In particular, by setting identification information that can be identified for each storage container volume obtained by dividing the predetermined storage space volume by a predetermined number as the reference storage space volume, it becomes possible to store delivery payloads in the storage space efficiently, like a puzzle, and it becomes possible to clarify the residual space volume as residual conversion storage container type information. Using this, it is possible to extract consolidation delivery information that indicates which of the user's deliveries can be consolidated into the residual space. This is explained in detail below.

The consolidation target delivery extraction part 152 extracts consolidation target delivery information that indicates the delivery of other users that can be consolidated with the user's delivery payload into the residual space. More specifically, the consolidation target delivery extraction part 152 extracts consolidation target delivery information that indicates deliveries that can be consolidated with the user's delivery payload in the residual space, based on, for example, storage container type information linked to the user identification information and residual space information linked to the delivery information of other users. In particular, by comparing the storage container type information linked to the user identification information with the residual space information linked to the delivery information of other users (in particular, the residual conversion storage container type information), the consolidation target delivery information corresponding to the residual conversion storage container type information that is equal to or greater than the volume indicated by the storage container type information linked to the user identification information is extracted. The residual converted storage container type information may be selected from multiple options, and for example, the residual space calculation part 151 may calculate the combination information of the residual converted storage container type information, (for example, a combination that allows two consolidation target objects of container type ¼ to be stored for residual space ½, a combination that allows one consolidation target object of container type ¼ and two consolidation target objects of container type ⅛ to be stored, or a combination that allows four consolidation target objects of container type ⅛ to be stored, etc.), and based on this combination information, the consolidation target delivery information may be extracted (more specifically, the comparison described above).

Here, other users are users corresponding to other user identification information associated with user identification information. Other user identification information may be, for example, co-residence user identification information set as a family member or a partner, or proxy user identification information set by the user as a proxy recipient. In this example, for the purpose of such association, for example, the user may execute a registration process for the other user's identification information on the application on the user's end, and/or execute a process to select whether or not to allow association with the user's identification information on the application on the other user's end, etc.

For example, the user or operator may be presented with a list of extracted other user delivery information on the application, and may be asked to select one from this list. Here, the extraction by the consolidation target delivery extraction part 152 may be further conditioned in addition to the residual space information. For example, when each delivery information includes delivery type information indicating whether it is a separate delivery or a consolidated delivery, the delivery information indicating a separate delivery may be selected as the target for extraction. Alternatively, for example, when each delivery information includes delivery type information indicating whether it is a normal delivery or a rush delivery (a delivery with a shorter time to delivery completion than a normal delivery), the delivery information may be selected as the target for extraction based on whether the delivery type information indicates a normal delivery or a rush delivery. Alternatively, for example, when the weight information linked to another user's delivery exceeds the standard weight information for consolidated shipping, or when the information on the temperature range linked to another user's delivery is higher or lower than the reference temperature range (for example, when it includes hot products or frozen foods), or when the information on whether consolidated delivery acceptance information indicates that consolidated delivery is not acceptable, etc., it may be excluded from the target for extraction. Conditioning may be satisfied by satisfying at least one of these.

In addition, a consolidated delivery permission confirmation may be presented to the other user related to the other user delivery information selected by the user or worker. When the other user selects consolidated delivery, it will be delivered as scheduled. When the user selects “not allowed”, the user or worker may be asked to select the other user's delivery information again in the application, or the delivery type information may be set as individual delivery without consolidation. For this, it may be possible to allow users to register other users who require permission confirmation in advance or who do not require permission confirmation, or to set it so that permission confirmation is not required. It may also be possible to set it so that permission confirmation from associated users is not required (or permission confirmation from non-associated users is required).

In this way, by taking into account the residual space in other users' storage space when making deliveries and by extracting other users' delivery payload information and consolidating it with the user's delivery payload, it becomes possible to deliver it together with other users' delivery payloads, taking into account the delivery unit (i.e., the number of deliveries determined by whether or not it fits into the reference storage space volume).

### <Processing Flow>

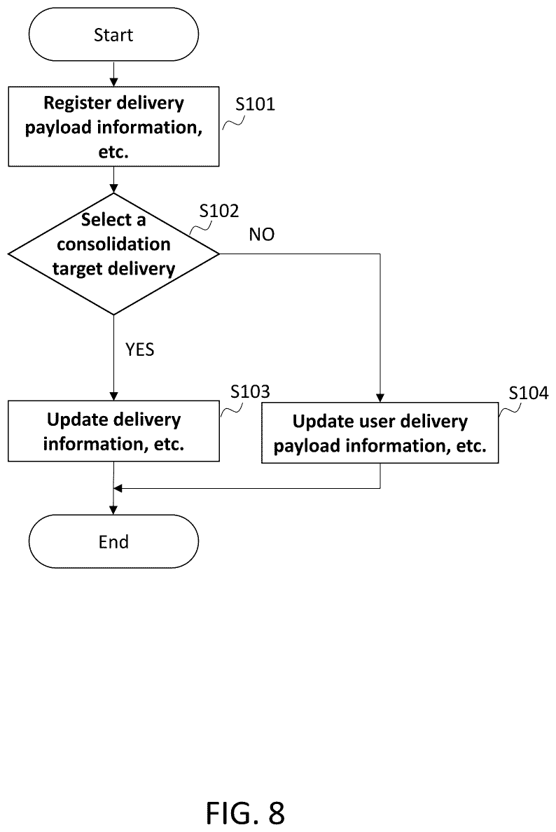

Referring to FIG. 8, the flow of the information processing method executed by the information processing system of this disclosure is explained. FIG. 8 is a flowchart showing an example of the processing of the information processing system in FIG. 1.

Here, the user or worker who is provided with this information processing system may access the management server 1 using an application (including a web browser), etc., and if they are using the service for the first time, they may perform the user registration process and log in, or if they have already obtained an account, they may log in by receiving the prescribed authentication, such as entering an ID and password, etc., and the service may be used. Alternatively, the service may be made available using the unique application ID associated with the application downloaded to the user terminal 2 or worker terminal 3 as the user identification information (ID). After this login authentication, the service can be used via applications (including web browsers).

First, in this example, the data management part 120 (in particular, the delivery management part 150) of the management server 1 generates new delivery payload identification information and delivery identification information in response to delivery payload acceptance processing, etc., such as reading the identification code attached to the delivery payload by a reader, and executes the registration of delivery payload information and delivery information (S101).

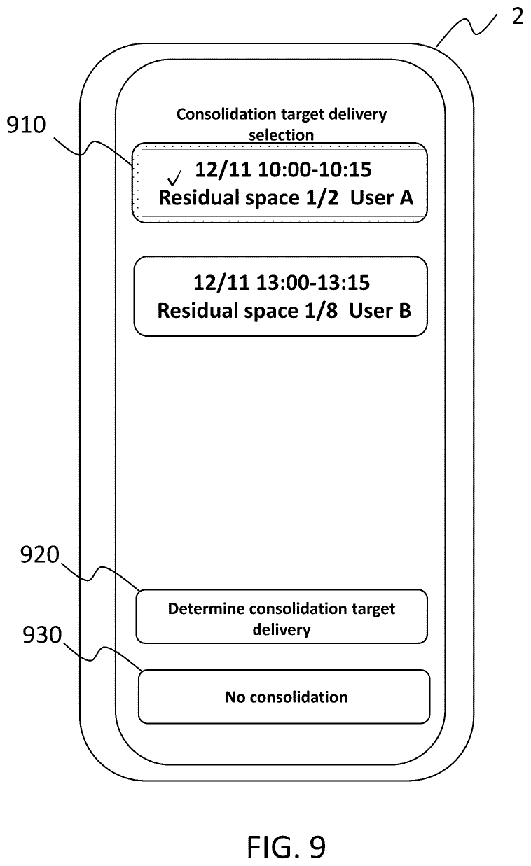

Next, the consolidation target delivery extraction part 152 extracts consolidation target delivery information that indicates the delivery of other users that can be consolidated with the user's delivery in the remaining space, and as shown in FIG. 9, a list of consolidation target delivery information 910 is displayed on the application, and the user or operator is allowed to select the desired consolidation target delivery information (Step S102). The consolidation target delivery information 910 displayed on the application can be, for example, delivery schedule time information, residual space information, and corresponding user information, but it is not limited to these, and it may also include weight information, temperature range information, and top/bottom stacking possibility information. In this example, the consolidation target delivery information with the scheduled delivery time information “10:00-10:15” is selected by the user or operator, and it is displayed differently from the unselected consolidation target delivery information. Furthermore, the “scheduled delivery time information” referred here may be the scheduled delivery time information that could be included in the delivery information, but it may also be the differential scheduled delivery time calculated from the difference between the relevant scheduled delivery time information and the current time (for example, if the scheduled delivery start time is “10:00” and the current time is “9:30”, the differential scheduled delivery time would be “30 minutes later”, etc.). In addition, when the corresponding consolidation target delivery information becomes unavailable for selection due to another user or operator having sent the same consolidation target delivery information to the management server 1 before the user or operator's decision-making operation, it may be possible to present a notification to the later user or operator, prompting them to select it again.

Rather than presenting it in the form of consolidation target item list information, the predetermined number of consolidation target delivery information extracted by the consolidation target delivery extraction part 152 may be presented as a selection option on the user or operator's application, allowing the user or operator to make a selection and decide on the consolidation target delivery. Alternatively, a predetermined number of consolidation target delivery information extracted by the consolidation target delivery extraction part 152 may be presented as a consolidation confirmation notice on the user or operator's application, allowing the user or operator to select whether or not to consolidate the delivery. The consolidation target delivery may be determined by the system without user or operator intervention from among the consolidation target delivery candidates extracted by the consolidation target delivery extraction part 152. In addition, even if the consolidation target delivery information is selected on the operator's application, it may be possible to present a consolidation confirmation notice and allow the user to select whether or not to consolidate, and then determine the consolidation target delivery. When the consolidation target delivery has been determined on the user's application or on this system, the relevant consolidation target delivery information may be displayed on the operator's terminal 3 so that the operator can check it during the storage operation. Furthermore, based on the consolidation target delivery information, the equipment used for storing the delivery payload (such as a storage robot, storage arm, or movable storage platform) may be controlled autonomously to retrieve the user's delivery payload from the delivery payload management space (e.g., a shelf) and store it in the storage space related to the consolidated delivery.

Next, for example, when the consolidation target delivery information is selected in response to a decision operation in the delivery schedule time determination area 920 (YES), the data management part 120 (in particular, the delivery management part 150) of the management server 1, based on the consolidated delivery information received from the user terminal 2, updates the delivery payload information related to the user's delivery (in particular, the updated delivery time information and consolidation target delivery information, and the consolidation acceptance/rejection information (information indicating rejection of consolidation)), and updates the delivery information related to other users' deliveries (in particular, the consolidation target delivery information and delivery type information (information indicating consolidation)) (S103). When further consolidation is not allowed for another user's delivery (for example, if consolidation is not allowed based on criteria such as the residual space volume after consolidation being below a standard value, or the weight after consolidation being above a standard value, or if it is not allowed based on settings by the user, or based on settings in this information processing system that do not allow multiple consolidations, etc.), the information on whether or not consolidation is acceptable may be updated to indicate that consolidation is not acceptable, even for other users' delivery information and delivery payload information.

In addition, in cases where payment processing related to delivery charges is performed before and after step S103 in particular, the delivery charges indicated by the delivery charge information related to the delivery of another user may be divided between the user and a predetermined ratio (e.g. split in two), and the delivery charge information after the division may be stored with each of them, so that each user can perform payment processing. Alternatively, it may be possible to only link and store the delivery charge for a single delivery for either the user or another user, and then perform the payment processing.

When the user's delivery payload has already been stored in a storage container compatible with the system, it is stored in the storage space associated with the consolidation target delivery as is. When it has not yet been stored, it is stored in a storage container of a storage container type calculated by the data management part 120 based on the delivery payload size information, etc., and then stored in the storage space associated with the consolidation target delivery, and delivered to the other user.

On the other hand, when there is no appropriate target among the consolidation target delivery information 910 displayed on the application, and there is a decision operation to the consolidated rejection decision area 930, or when there is no delivery information that can be a candidate for consolidation, or when there is no selection of consolidation target delivery information by a specified period before the scheduled delivery time of the user (NO), the data management part 120 (particularly the delivery management part 150) updates the user's delivery payload information and delivery information by, for example, updating the delivery type information to indicate individual delivery without consolidation, calculating the residual space, and updating the residual space information contained in the delivery information (S104).

As a result, when a consolidation target delivery is not selected, the user's delivery payload can be a target of extraction by the consolidation target delivery extraction part 152. In addition, it may comprise a structure that allows for multiple consolidations.

As described above, by using storage container type information to standardize and manage delivery payloads (e.g. loads such as packages), it is possible to provide an information processing system and server, information processing method, and program that make it easier to grasp the overall quantity of delivery payloads and enable efficient storage in various storage spaces.

The above embodiments are merely examples to facilitate understanding of this disclosure and are not intended to limit the scope of this disclosure. It goes without saying that this disclosure may be changed or improved without deviating from its purpose, and that this disclosure includes equivalents thereof.

### DESCRIPTION OF REFERENCE NUMERALS

1 Management server
2 User terminal

1. An information processing system, comprising:
a residual space calculation part that, based on storage container type information indicating the type of each storage container according to the volume of the storage container that stores a delivery payload for a user and reference storage space volume information indicating the volume of the storage space that stores one or more storage containers, calculates residual space information indicating a residual space within the storage space; and
a consolidation target delivery extraction part that extracts consolidation target delivery information indicating a delivery payload of other users that can be consolidated with the delivery payload of the user in the residual space.

2. The information processing system according to claim 1,
wherein the storage container type information is made mutually identifiable based on the volume obtained by dividing the reference storage space volume by a predetermined number, with the predetermined storage space volume serving as the reference storage space volume.

3. The information processing system according to claim 1,
wherein the residual space information is residual converted storage container type information that converts the residual space into storage container types.

4. The information processing system according to claim 1, further comprising:
a data management part that transmits the extracted consolidation target delivery information to an operator terminal.

5. A server, comprising:
a residual space calculation part that, based on storage container type information indicating the type of storage container for storing a delivery payload for a user and reference storage space volume information indicating the volume of a storage space that stores one or more storage containers, calculates residual space information indicating the residual space in the storage space; and
a consolidation target delivery extraction part that extracts consolidation target delivery information indicating a delivery payload of other users that can be consolidated with the delivery payload of the user in the residual space.

6. An information processing method, comprising:
a step of calculating, based on storage container type information indicating the type of storage container for storing a delivery payload for a user and reference storage space volume information indicating the volume of a storage space that stores one or more storage containers, residual space information indicating a residual space within the storage space;
a step of extracting consolidation target delivery information indicating a delivery of another user that can be consolidated with the delivery payload of the user in the residual space by the consolidation target delivery extraction part.

7. (canceled)

8. The information processing system according to claim 2,
wherein the residual space information is residual converted storage container type information that converts the residual space into storage container types.

9. The information processing system according to claim 2, further comprising:
a data management part that transmits the extracted consolidation target delivery information to an operator terminal.

10. The information processing system according to claim 3, further comprising:
a data management part that transmits the extracted consolidation target delivery information to an operator terminal.

11. The information processing system according to claim 8, further comprising:
a data management part that transmits the extracted consolidation target delivery information to an operator terminal.
